(19) United States
(12) Patent Application Publication
(10) Pub. No.: US 2006/0079254 A1
(43) Pub. Date: Apr. 13, 2006

(54) Method and apparatus for updating a control file

(76) Inventor: Timothy James Hogan, Wellington (NZ)

Correspondence Address: UNISYS CORPORATION, UNISYS WAY, MAILSTOP E8-114, BLUE BELL, PA, 19424-0001, US

(21) Appl. No.: 10/545,037

(22) PCT Filed: Feb. 11, 2003
(86) PCT No.: PCT/NZ03/00021

§ 371 Date: Aug. 11, 2005

(51) Int. Cl. H04Q 7/20

(52) U.S. Cl. 455/466; 709/215

(57) ABSTRACT

A method of simultaneously upgrading control files in mobile devices (5) and remote devices (45) utlising Cell Broadcast messages. A control file is divided into a number of packets which are sent in the user data sections (18, 20) of a sequence of Cell Broadcasts messages. The mobile data (5) or remote device (45) reassembles the packets (18, 20) and loads the control file if it passes error-checking tests. The control file may be operating software, operational parameters, control commands or SIM card files. The remote device may be a monitoring device, a consumer appliances, a vending machine etc. The method provides simultaneous “Flash upgrades” to multiple mobile devices in a transparent manner with minimal network overhead. A system for effecting the method and a remotely updatable device are also disclosed.

### FIELD OF THE INVENTION

The invention relates to a method of updating a control file and systems and devices for implementing the method. Cell Broadcast messages are utilised to simultaneously send portions of a control file to remote devices to update control files of the remote devices.

### BACKGROUND TO THE INVENTION

GSM mobile networks have the capability of sending out data using a push only technique known as “Cell Broadcast”. This is a one to many technique enabling network operators to send content such as news, geographical information, weather forecasts etc to selected customers. This technique is similar to the “teletext” facility available in television systems.

A Cell Broadcast message may be broadcast to all mobile devices with no acknowledgement being returned by the mobile devices, unlike the short message service (SMS) where an acknowledgement is returned.

Mobile devices such as mobile phones store operating software controlling the operation of the device. It is sometimes desirable to update the operating software of a mobile device. Such software updating is typically effected in a peer-to-peer manner. This may involve physical delivery of a mobile device to a provider to effect a software update. For a cell phone this may require the issuance of a replacement SIM (Subscriber Identity Module) card.

There are a number of other remote devices, such as utility meters, monitoring devices, consumer appliances, security systems and vending machines for which it would be convenient to remotely and simultaneously update control files, including software files or operating parameter files. It would also be convenient to issue commands to such devices remotely.

### SUMMARY OF THE INVENTION

It is an object of the present invention to provide a method of simultaneously updating control files of a plurality of remote devices in a convenient and efficient manner or to at least provide the public with a useful choice.

According to a first aspect of the invention there is provided a method of transferring a control file from a source device to a remote device via a cellular communication link comprising the steps of:
i. packing a control file into one or more Cell Broadcast message;
ii. transmitting the one or more Cell Broadcast message via one or more wireless transmitter;
iii. receiving the Cell Broadcast messages at a remote device; and
iv. extracting and reassembling the control file at the remote device.

The control file may be operating software, firmware software, one or more operational parameter or one or more control command. The remote device may be a cellphone, utility meter, monitoring device, consumer appliance (e.g. a digital decoder, video recorder, fridge etc), security system, vending machine etc.

Each Cell Broadcast message may include error-checking data. A final Cell Broadcast message may include error-checking data to enable error-checking of the reassembled control file. Each message may include a generic device type data section and a specific device type data section. An acknowledgement may be sent by the remote device once an updated control file has been loaded via a communication method other than the Cell Broadcast method.

According to further aspect of the invention there is provided a system for simultaneously sending a control file to a plurality of remote devices via a cellular communications network including:
a central controller which divides the control file into a plurality of data packets and provides the data packets to a plurality of wireless transmitters of a cellular communication network; and
a plurality of wireless transmitters of a cellular communication system which transmit the data packets as part of Cell Broadcast messages to each remote device.

There is further provided a remotely updatable device programmed to operate in accordance with a control file comprising:
a radio receiver capable of receiving Cell Broadcast messages;
a processor for extracting user data from Cell Broadcast messages and assembling it into a control file; and
programmable memory for storing a received assembled control file.

The programmable memory may store operating software, SIM card files, one or more operational parameter or one or more control command. The programmable memory may be an EPROM, EEPROM, Flash or similar memory. The device may be responsive to a control command to initiate an action. The device may be a cellular phone, utility meter, monitoring device, consumer appliance, security device, vending machine etc.

### BRIEF DESCRIPTION OF THE DRAWINGS

The invention will now be described by way of example with reference to the accompanying drawings in which:

FIG. 1: shows a GSM cellular communication network and a number of connected mobile devices;

FIG. 2: shows the format of a Cell Broadcast message;

FIGS. 3a to 3d: show a sequence of Cell Broadcast messages carrying a payload consisting of packets of a control file;

FIG. 4: shows the structure of the CB User Data field of the messages sent in FIGS. 3a to 3d;

FIG. 5: shows the steps involved in sending a control file to a remote device;

FIG. 6: shows a GSM cellular network with a plurality of remote devices connected by mobile devices; and

FIG. 7: shows a block diagram of a remote device and mobile device as shown in FIG. 6.

### DETAILED DESCRIPTION OF EMBODIMENTS OF THE INVENTION

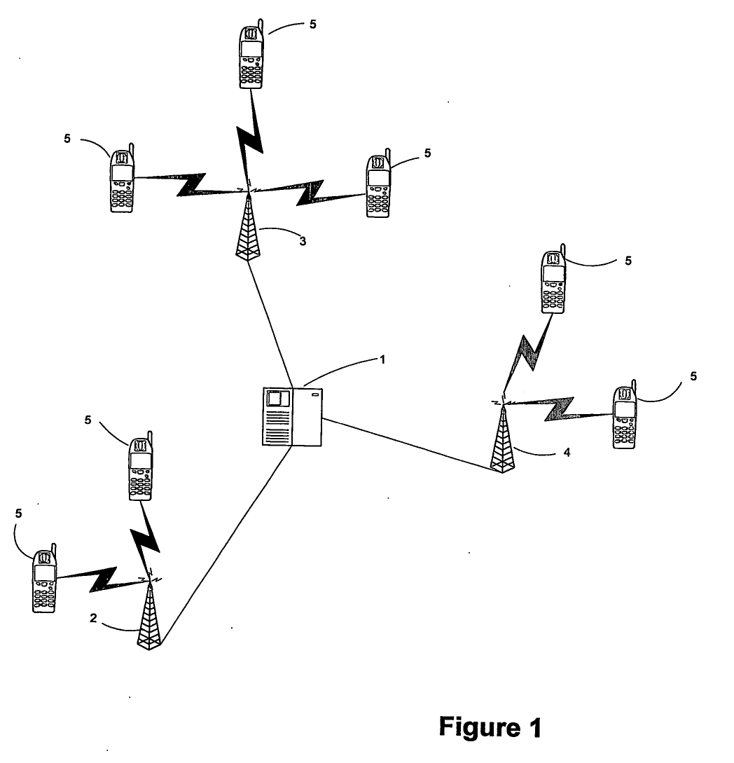

FIG. 1 shows a block diagram of part of a GSM cellular network including a central controller 1 connected to three transmitters 2, 3 and 4. A plurality of mobile devices 5 receive transmissions from respective transmitters within respective cells. The GSM mobile network has the capability of sending Cell Broadcast messages simultaneously from central controller 1 to transmitters 2, 3 and 4 for reception by all connected mobile devices 5. Such messages typically include content such as the geographical location of a cell, weather information, news etc.

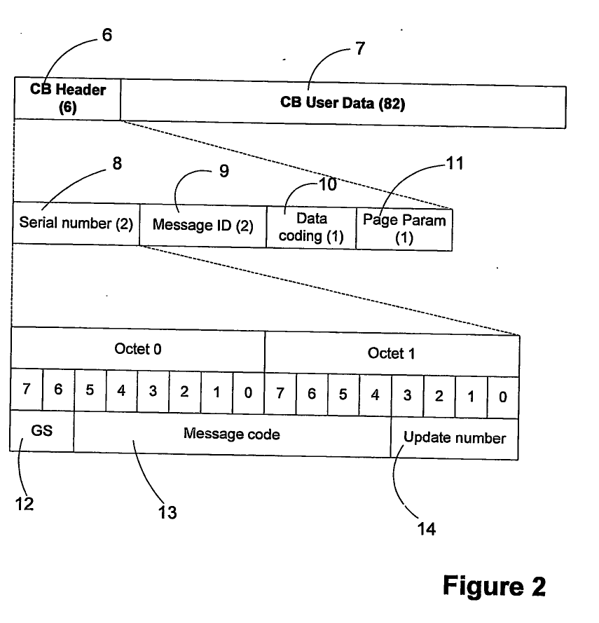

FIG. 2 shows the format of a standard Cell Broadcast message. Each message consists of a Cell Broadcast Header field 6 (CB Header) of 6 bytes and a user data field 7 (CB User Data) of 82 bytes. The CB Header field 6 consists of a two byte serial number field 8, a two byte message ID field 9, a one byte data coding field 10 and a one byte page parameter field 11.

The serial number field 8 consists of a two bit geographical scope (GS) field 12, a ten bit message code field 13 and a four bit update number field 14. The geographical scope field enables control of the range of broadcast of a Cell Broadcast message and display options. A geographical scope value of 3 enables a cell wide broadcast without the message being displayed. Alternatively a Cell Broadcast message may be sent only to a selected geographic region.

Message ID field 9 gives the channel number. A large number of channels are available to network operators for network specific Cell Broadcasts. Data coding field 10 defines the data format (e.g. GSM 7). Page parameter field 11 includes 4 bits indicating the current page number and 4 bits indicating the total number of pages.

Mobile devices 5 include programmable memory for storing operating software which controls the operation of the mobile devices 5. According to the method of the invention “Flash upgrades” of operating software may be sent to mobile devices 5 utilising the Cell Broadcast facility. Updated operating software may be sent in one or more packet of user data of Cell Broadcast messages to the mobile devices 5. Mobile devices 5 may reassemble the packets of data and install the updated operating software. This enables the operating software of multiple devices to be upgraded simultaneously in a manner that is imperceptible to the user.

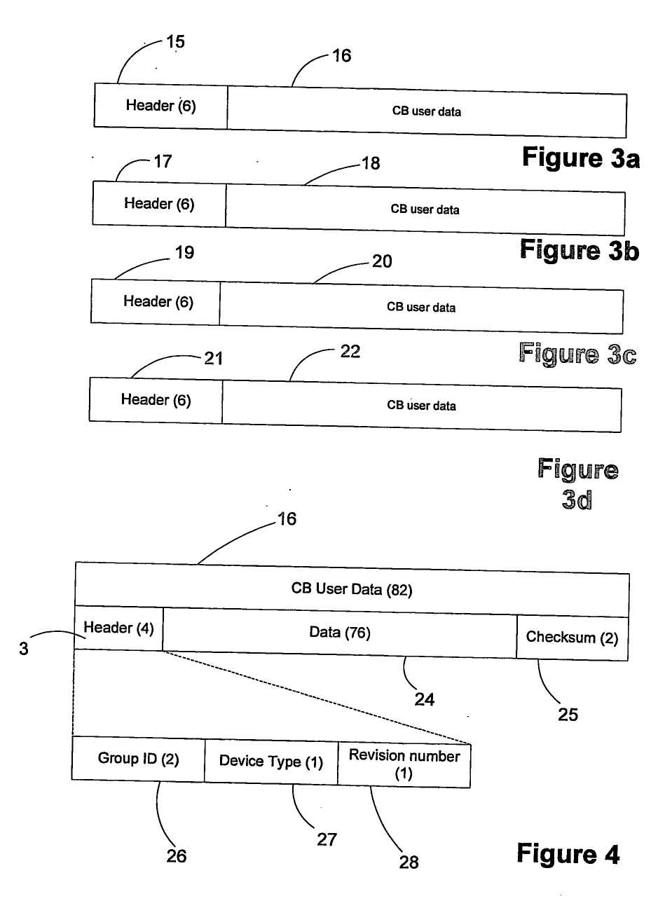

Referring to FIGS. 3a to 4 a possible format of Cell Broadcast messages to facilitate “flash upgrades” of operating software will be described. Similar formats may be used in keeping with the teachings of this invention. The exact configuration may vary from system to system and different device types as well. FIGS. 3a to 3d show a sequence of Cell Broadcast messages used to send packets of “payload” data to mobile devices 5 to update their operating software. Each Cell Broadcast message consists of a header 15, 17, 19 and 21 and a user data section 16, 18, 20 and 22.

FIG. 4 shows the currently preferred format of the user data portion of each Cell Broadcast message. Of the 82 bytes of user data 16, four bytes are allocated to header 23 and two bytes are allocated to an error-checking data field 25. This leaves 76 bytes of “payload” data 24. Header 23 includes a 2 byte group ID field which is used to identify the generic device type for which the message is intended and a 1 byte device type field 27 which is used to identify the specific device type for which the message is intended. Preferably, the generic device type field 26 may define a general category of device whereas the specific device type field 27 may define a specific model or models. The revision number field 28 (in this case a one byte field) indicates the version of the upgrade so that a receiving device can determine whether it needs to load the upgrade.

The message code field 13 shown in FIG. 2 may be utilised to indicate the number of a packet in a sequence of packets. With ten bits this enables 1024 packets to be identified (i.e. 77824 bytes). The update number field 14 may be utilised to indicate the number of a transmission series where an update is transmitted many times. The geographical scope field 12 may be set to 3 so that the Cell Broadcast messages are sent cell wide without being displayed.

The user data of a first Cell Broadcast message in a series (FIG. 3a) may be a special data description packet which contains information about the complete payload. Intermediate Cell Broadcast messages (FIGS. 3b and 3c) may contain payload data being packets of the operating software file, type of error checking employed, security measures employed etc. The number of intermediate Cell. Broadcast messages may vary depending upon the length of the operating software file, type of error checking employed, security method employed etc. The final Cell Broadcast message (FIG. 3d) may contain error-checking data to enable the reassembled operating software file to be error-checked.

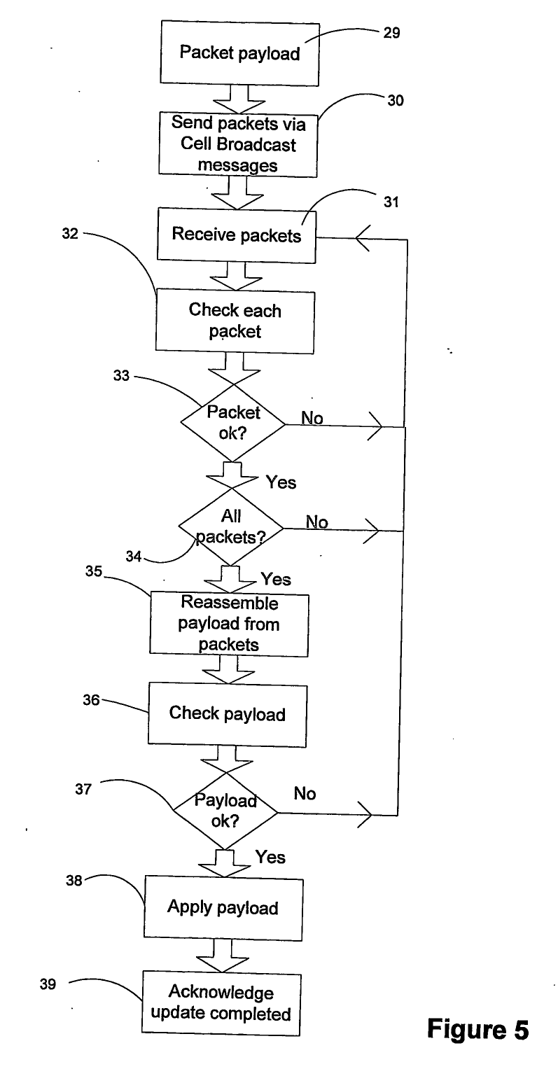

FIG. 5 shows a flow diagram of the currently preferred process of updating an operating software file. In step 29 an operating software file is divided into 76 byte packets to be packed into field 24 (FIG. 4). A checksum value is generated for field 25 based upon the data contained in field 24 using an error-checking algorithm such as a CRC. The group ID field 26 and device type field 27 are assigned depending upon the target device. A revision number is assigned to field 28. The geographical scope field 12 (FIG. 2) is set to the value “3” and the packet number is inserted in field 13. The update number 14 is incremented for each transmission of the entire series (from 0 to 15 and cycling back to 0). As mobile devices may not always be switched on and all packets may not be accurately received the entire sequence of packets may be sent periodically. Message ID field 9 is set depending upon the Channel selected by the network operator. Data coding field 10 will typically be set to GSM 7 and page parameter field 11 is not used.

The first packet is a data description packet and the last packet is an error-checking packet for the entire reassembled operating software file. The intermediate packets are portions of the operating software file.

In step 30 the packets are sent via Cell Broadcast messages transmitted by the GSM cellular network. These are received by each connected mobile device 5 in step 31. In step 32 a processor of each mobile device 5 checks each packet of user data 16 in each message received. Fields 26 and 27 are checked to see whether the device is an intended recipient of the message. Revision number field 28 is checked to see whether the update is a newer version than the current operating software that needs to be loaded. Error-checking of data 24 is carried out using checksum 25. If the device is not an intended recipient, the update does not need to be loaded or error-checking fails processing returns to step 31. If the packet passes all checks the packet is stored and processing moves to step 34. If all packets in a series have not been received processing returns to step 31. If all packets have been received the operating software is reassembled from the packets in step 35.

In step 36 the reassembled operating software is error checked using the error checking information 22 in the final Cell Broadcast message (FIG. 3d). If error-checking fails processing returns to step 31. If error-checking is successful the new operating software is loaded in step 38. An acknowledgement may be sent via SMS or GPRS to the network operator if desired in step 39.

Although the above description is in relation to an operating software file is to be appreciated that it applies equally to any type of control file.

Where security is required the payload may be encrypted with each mobile device having appropriate decryption functionality. Further, the hardware design of the mobile device many be such as to enhance security also.

An operator of a GSM network has the ability to personalize mobile phones by programming network specific features, such as menus, into SIM cards or the like. Updating these cards is inconvenient as the customer must either bring their phone in all the network operator must send out a new SIM card. The method previously described enables an operator to update the software and/or data of the SIM card components using Cell Broadcast messages.

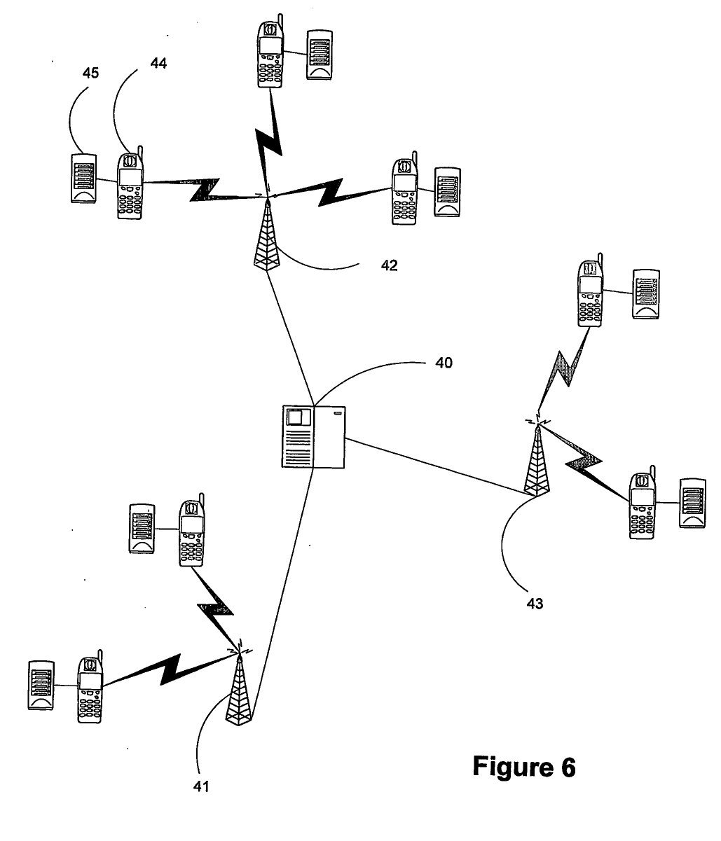

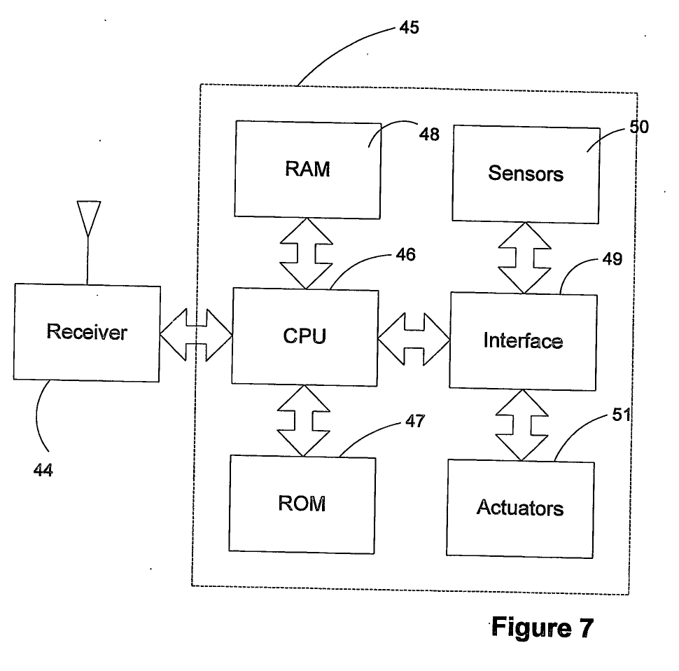

Referring now to FIGS. 6 and 7 an embodiment of a system for updating control files of remote devices is shown. Central controller 40 generates Cell Broadcast messages to be sent by transmitters 41 to 43 of a GSM network, as in the network shown in FIG. 1. In this case the remote devices include a receiver 44 and a control unit 45. The receiver 44 may be a standard mobile device Interfaced to control unit 45 via a cable or wireless connection such as an infrared or Bluetooth link. Alternatively receiver 44 and control unit 45 may be an integrated unit. Control unit 45 may be associated with a utility meter, monitoring device, consumer appliances, security system, vending machine etc.

As shown in FIG. 7 the control unit 45 may Include a central processing unit 46, programmable memory 47 which stores operating software and operational parameters, temporary memory 48, and an interface unit 49 for interfacing between the CPU 46 and sensors 50 and actuators 51.

In a vending application sensors 50 may sense characteristics of coins placed in the vending machine and actuators 51 may control the release of the vended product and coins etc. Operating software may be stored in programmable memory 47 which may be updated utilising Cell Broadcast messages as previously described. Further, operating parameters (i.e. parameters which govern the operation of a device, such as coin characteristic parameters which define acceptable coins) may be stored in programmable memory 47 which may also be updated utilising the Cell Broadcast method previously described. This avoids the need for a technician to update each individual device and enables rapid and simultaneous updating of an entire system.

The Cell Broadcast method previously described may also be utilised to send commands to connected devices. For example, in an environmental sensing application a control command may be sent to all connected devices instructing them to obtain a measurement from a sensor upon receipt of a control command. In a security application a command may be sent to check security sensors and send a status report to a central monitoring station.

In view of the typical error rates of mobile connections it is desirable to send a number of small packets of data rather than one or a few large packets. Should an error occur in a large packet the entire packet must be resent whereas for small packets only one or a small number must be resent. The use of Cell Broadcast messages is thus advantageous within a cellular network.

By modular design of operating system software those parts most likely to require updating may be stored in separate files to facilitate updating. This lessens the amount of data that must be sent to achieve an upgrade and so increases efficiency and reliability.

There is thus provided a method enabling the simultaneous updating of control files of a plurality of remote devices via Cell Broadcast messages in a manner that is transparent to the end user. The method is particularly advantageous where a large number of devices need to be updated with a relatively small amount of data. The method is rapid and imposes minimal overhead on a network provider. The method enables a frequency of upgrade of control files that would not be possible on a peer to peer basis. The method may be used to update SIM cards. The method may also be utilised to send commands to remote devices.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A method of transferring a control file from a source device to a remote device via a cellular communication network comprising the steps of:
i. packing a control file into one or more Cell Broadcast message;
ii. transmitting the one or more Cell Broadcast message via one or more wireless transmitter;
iii. receiving the Cell Broadcast messages at a remote device; and
iv. extracting and reassembling the control file at the remote device.

2. A method as claimed in claim 1 including the step of integrating the control file into said remote device.

3. A method as claimed in claim 1 including the step of executing instructions in said control file in said remote device.

4. A method as claimed in any one of the preceding claims wherein the control file is divided into a plurality of packets in step i.

5. A method as claimed in any one of claims 1 to 4 wherein the control file is operating software.

6. A method as claimed in any one of claims 1 to 4 wherein the control file contains one or more operational parameter.

7. A method as claimed in any one of claims 1 to 4 wherein the control file includes one or more control command.

8. A method as claimed in any one of claims 1 to 4 wherein the control file is a SIM card file.

9. A method as claimed in any one of claims 1 to 8 wherein the remote device is a cellular phone.

10. A method as claimed in any one of claims 1 to 7 wherein the remote device includes a utility meter.

11. A method as claimed in any one of claims 1 to 7 wherein the remote device includes a monitoring device.

12. A method as claimed in any one of claims 1 to 7 wherein the remote device includes a consumer appliance.

13. A method as claimed in any one of claims 1 to 7 wherein the remote device includes a security system.

14. A method as claimed in any one of claims 1 to 7 wherein the remote device includes a vending machine.

15. A method as claimed in any one of the preceding claims wherein each packet of user data sent in each Cell Broadcast message includes error-checking data.

16. A method as claimed in any one of the preceding claims wherein a final message is sent containing error-checking data to enable error checking of the reassembled control file.

17. A method as claimed in any one of the preceding claims wherein each message includes a generic device type data section.

18. A method as claimed in claim 17 wherein each message packet includes a specific device type data section.

19. A method as claimed in any one of the preceding claims wherein each message includes a revision number data section.

20. A method as claimed in any one of the preceding claims wherein the message code field of a Cell Broadcast message is used to indicate the number of a message packet in a sequence of packets.

21. A method as claimed in any one of the preceding claims wherein an acknowledgement is sent to the source device when updated control file has been loaded.

22. A system for simultaneously sending a control file to a plurality of remote devices via a cellular communications network including:
a central controller which divides the control file into a plurality of data packets and provides the data packets to a plurality of wireless transmitters of a cellular communication network; and
a plurality of wireless transmitters of a cellular communication system which transmit the data packets as part of Cell Broadcast messages to each remote device.

23. A system as claimed in claim 22 wherein the system generates error-checking data as part of each data packet.

24. A system as claimed in claim 22 or claim 23 wherein the system generates a final data packet containing error-checking information to enable error-checking of the reassembled control file.

25. A system as claimed in any one of claims 22 to 24 wherein the system generates a generic device type data section for inclusion in each Cell Broadcast message.

26. A system as claimed in any one of claims 22 to 25 wherein the system generates a specific device type data section for inclusion in each Cell Broadcast message.

27. A system as claimed in any one of claims 22 to 26 wherein the system generates a revision number data section for inclusion in each Cell Broadcast message.

28. A remotely updatable device programmed to operate in accordance with a control file comprising:
a radio receiver capable of receiving Cell Broadcast messages;
a processor for extracting user data from Cell Broadcast messages and assembling it into a control file; and
programmable memory for storing a received assembled control file.

29. A device as claimed in claim 28 wherein the programmable memory stores operating software that is updatable by a control file received in Cell Broadcast messages.

30. A device as claimed in claim 28 wherein the programmable memory stores firmware software that is updatable by a control file received in Cell Broadcast messages.

31. A device as claimed in claim 28 wherein the programmable memory stores one or more operational parameter that is updatable by a control file received in Cell Broadcast messages.

32. A device as claimed in claim 28 wherein the programmable memory stores one or more control command that is updatable by a control file received in Cell Broadcast messages.

33. A device as claimed in claim 28 wherein the device is responsive to one or more control command sent as part of a Cell Broadcast to initiate an action.

34. A device as claimed in any one of claims 28 to 33 wherein the device is a cellular phone.

35. A device as claimed in any one of claims 28 to 33 wherein the device includes a utility meter which operates in accordance with the control file.

36. A device as claimed in any one of claims 28 to 33 wherein the device includes a monitoring device which operates in accordance with the control file.

37. A device as claimed in any one of claims 28 to 33 wherein the device includes a consumer appliance which operates in accordance with the control file.

38. A device as claimed in any one of claims 28 to 33 wherein the device includes a security device which operates in accordance with the control file.

39. A device as claimed in any one of claims 28 to 33 wherein the device includes a vending machine which operates in accordance with the control file.

40. A device as claimed in any one of claims 28 to 39 wherein the programmable memory is EPROM, EEPROM or Flash memory.

41. A device as claimed in any one of claims 28 to 39 wherein the programmable memory is a SIM card

42. A system including a system as claimed in any one of claims 22 to 27 and one or more remotely updatable device as claimed in any one of claims 28 to 41.

43. A system for performing the method of any one of claims 1 to 21.
